(19) United States
(12) Patent Application Publication
(10) Pub. No.: US 2026/0369477 A1
(43) Pub. Date: Nov. 19, 2026

(54) ELECTRONIC COMPONENT AND METHOD FOR MANUFACTURING ELECTRONIC COMPONENT

(71) Applicant: Murata Manufacturing Co., Ltd., Nagaokakyo-shi (JP)

(72) Inventor: Hiroyuki HONDA, Nagaokakyo-shi (JP)

(21) Appl. No.: 19/733,332

(22) Filed: Jul. 7, 2026

Related U.S. Application Data
(63) Continuation of application No. PCT/JP2025/001695, filed on Jan. 21, 2025.

(30) Foreign Application Priority Data
Jan. 24, 2024 (JP) 2024-008733

(51) Int. Cl. H01G 4/232; H01G 4/248; H01G 13/00

(52) U.S. Cl. CPC H01G 4/2325; H01G 4/248; H01G 13/006

(57) ABSTRACT

An electronic component that includes: an element body; and an external electrode covering an outer surface of the element body. The external electrode has a base electrode that includes a plurality of copper particles and a filler. The base electrode has a chain-shaped portion in which a plurality of the copper particles are connected. When the base electrode is viewed in a cross section orthogonal to the outer surface of the element body, the filler is filled in a plurality of gaps between mutually different portions of the chain-shaped portion.

### CROSS REFERENCE TO RELATED APPLICATIONS

The present application is a continuation of International application No. PCT/JP2025/001695, filed Jan. 21, 2025, which claims priority to Japanese Patent Application No. 2024-008733, filed Jan. 24, 2024, the entire contents of each of which are incorporated herein by reference.

### TECHNICAL FIELD

The present disclosure relates to an electronic component and a method for manufacturing an electronic component.

### BACKGROUND ART

An electronic component disclosed in Patent Document 1 has an element body, an internal electrode, and an external electrode. The internal electrode is located inside the element body. The external electrode has a base electrode and a metal layer. The base electrode covers a part of an outer surface of the element body. The base electrode includes copper. The metal layer covers an outer surface of the base electrode.

Patent Document 1: Japanese Patent No. 5206440

### SUMMARY OF THE DISCLOSURE

In an electronic component such as the electronic component disclosed in Patent Document 1, voids not filled with copper or resin may exist inside the base electrode. As more such voids exist, a liquid such as a plating solution used when forming the metal layer enters the inside of the base electrode easily. When the liquid enters the inside of the base electrode, the base electrode may peel from the element body, or cracks may easily occur in the base electrode.

To solve the above problem, the present disclosure is an electronic component including: an element body; and an external electrode covering an outer surface of the element body, wherein the external electrode has a base electrode that includes a plurality of copper particles and a filler, the base electrode has a chain-shaped portion in which a plurality of the copper particles are continuously connected from the outer surface of the element body to an outer surface of the base electrode on a side thereof opposite to the element body, and in which the plurality of the copper particles are connected over 100 nm or more in a direction along the outer surface of the element body, when viewed in a cross section orthogonal to the outer surface of the element body, a gap is defined between mutually different portions of the chain-shaped portion, and the filler is in the gap.

In addition, the present disclosure is a method for manufacturing an electronic component, the method including: preparing an element body; preparing a conductor paste in which an amine and a carboxylic acid are added to a solution including copper; applying the conductor paste to an outer surface of the element body; and curing the conductor paste to form a base electrode on the outer surface of the element body.

Entry of a liquid into the inside of the base electrode can be suppressed.

### BRIEF DESCRIPTION OF THE DRAWINGS

FIG. 1 is a perspective view of an electronic component.

FIG. 2 is a side view of the electronic component.

FIG. 3 is a sectional view of the electronic component.

FIG. 4 is an enlarged sectional view of an external electrode.

FIG. 5 is an enlarged sectional view of a base electrode.

FIG. 6 is a flowchart of a method for manufacturing the electronic component.

### DESCRIPTION OF THE PREFERRED EMBODIMENTS

### <One Embodiment of Electronic Component and Method for Manufacturing Electronic Component>

One embodiment of an electronic component and a method for manufacturing the electronic component will be described below. The drawings are schematic diagrams provided to facilitate understanding, and components may be enlarged or omitted. Accordingly, the dimensional ratios of the components may differ from the actual dimensional ratios.

### (Overall Configuration of Electronic Component)

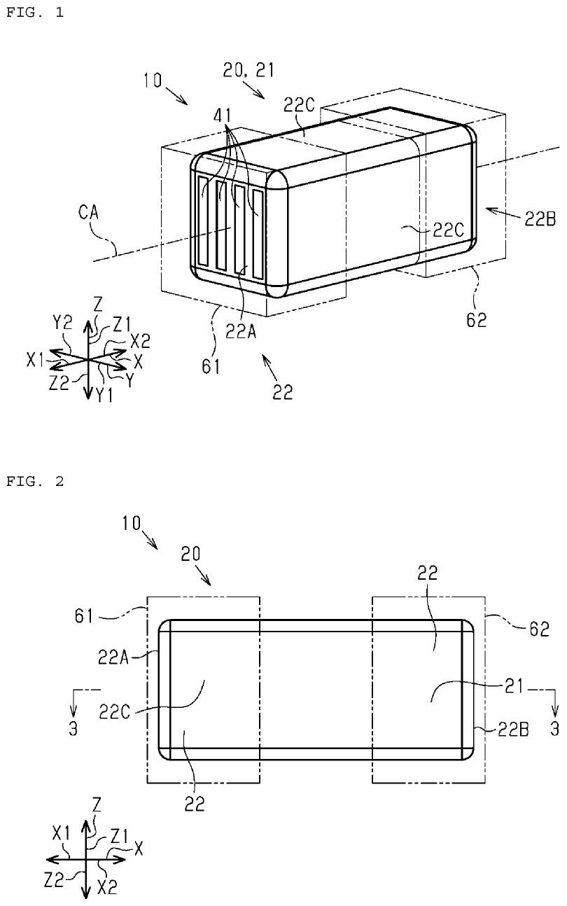

As shown in FIG. 1, the electronic component 10 is a multilayer ceramic capacitor. The electronic component 10 includes an element body 20. The element body 20 has a substantially quadrangular prism shape and has a central axis CA. In the following description, an axis extending along the central axis CA is defined as a first axis X. One of axes orthogonal to the first axis X is defined as a second axis Y. An axis orthogonal to the first axis X and the second axis Y is defined as a third axis Z. Furthermore, one direction along the first axis X is defined as a first positive direction X1, and a direction along the first axis X opposite to the first positive direction X1 is defined as a first negative direction X2. One direction along the second axis Y is defined as a second positive direction Y1, and a direction along the second axis Y opposite to the second positive direction Y1 is defined as a second negative direction Y2. Furthermore, one direction along the third axis Z is defined as a third positive direction Z1, and a direction along the third axis Z opposite to the third positive direction Z1 is defined as a third negative direction Z2.

An outer surface 21 of the element body 20 has six planar surfaces 22. As used herein, the “surface” of the element body 20 refers to a portion that can be observed as a surface when the entire element body 20 is observed. In other words, even when a minute irregularity or step that is not recognizable unless a part of the element body 20 is magnified and observed with a microscope or the like is present, that portion is referred to as a planar surface or a curved surface. The six planar surfaces 22 face mutually different directions. The six planar surfaces 22 are broadly classified into a first end surface 22A facing the first positive direction X1, a second end surface 22B facing the first negative direction X2, and four side surfaces 22C. The four side surfaces 22C are respectively a surface facing the third positive direction Z1, a surface facing the third negative direction Z2, a surface facing the second positive direction Y1, and a surface facing the second negative direction Y2.

In the outer surface 21 of the element body 20, boundary portions between two adjacent planar surfaces 22 and boundary portions among three adjacent planar surfaces 22 are curved surfaces. That is, corners of the element body 20 have an R-chamfered shape.

As shown in FIGS. 1 and 2, the element body 20 has a dimension in the direction along the first axis X larger than a dimension in the direction along the second axis Y and a dimension in the direction along the third axis Z. A material of the element body 20 is dielectric ceramic. Specifically, the material of the element body 20 includes BaTiO₃ as a main component. The material of the element body 20 may include CaTiO₃, SrTiO₃, CaZrO₃, or the like as a main component. The material of the element body 20 may include, as a subcomponent, a Mn compound, a Co compound, a Si compound, a compound including a rare earth element, or the like.

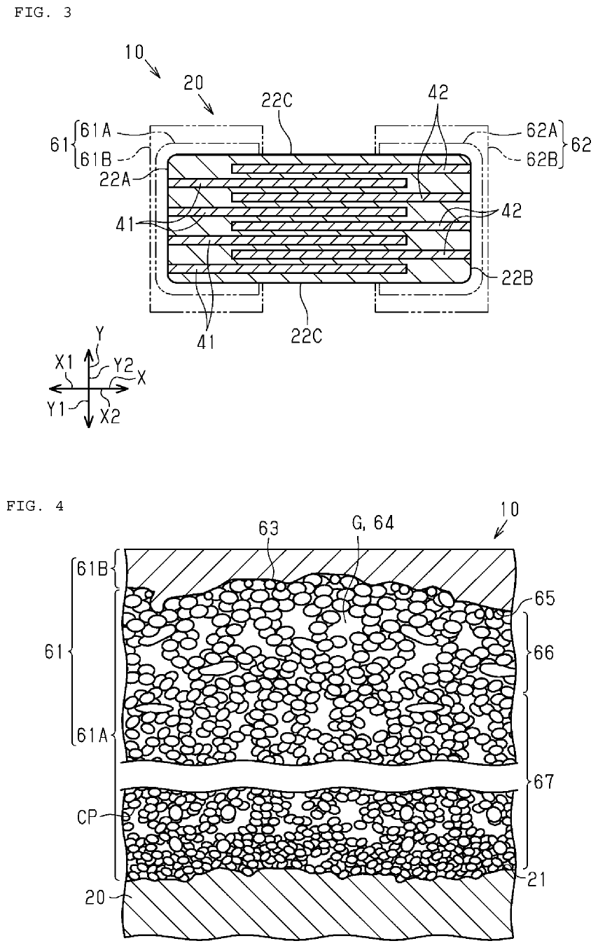

As shown in FIG. 3, the electronic component 10 includes four first internal electrodes 41 and four second internal electrodes 42. The first internal electrodes 41 and the second internal electrodes 42 are embedded inside the element body 20.

A material of the first internal electrodes 41 is an electrically conductive material. Specifically, the material of the first internal electrodes 41 is Ni. A material of the second internal electrodes 42 is the same as the material of the first internal electrodes 41.

A shape of each first internal electrode 41 is a rectangular plate shape. Main surfaces of the first internal electrodes 41 are orthogonal to the second axis Y. A shape of each second internal electrode 42 is the same rectangular plate shape as each first internal electrode 41. Main surfaces of the second internal electrodes 42 are orthogonal to the second axis Y, as with the first internal electrodes 41.

A dimension of each first internal electrode 41 in the direction along the first axis X is smaller than a dimension of the element body 20 in the direction along the first axis X. As shown in FIG. 1, a dimension of each first internal electrode 41 in the direction along the third axis Z is approximately two thirds of a dimension of the element body 20 in the direction along the third axis Z. Dimensions of each second internal electrode 42 in respective directions are substantially the same as the dimensions of each first internal electrode 41.

As shown in FIG. 3, the first internal electrodes 41 and the second internal electrodes 42 are alternately located in the direction along the second axis Y. That is, the first internal electrodes 41, the second internal electrodes 42, the first internal electrodes 41, and the second internal electrodes 42 are arranged in this order from the side surface 22C facing the second positive direction Y1 toward the second negative direction Y2. In the present embodiment, distances between the internal electrodes in the direction along the second axis Y are equal.

As shown in FIG. 1, the four first internal electrodes 41 and the four second internal electrodes 42 are both located at the center of the element body 20 in the direction along the third axis Z. On the other hand, as shown in FIG. 3, the first internal electrodes 41 are shifted toward the first positive direction X1. The second internal electrodes 42 are shifted toward the first negative direction X2.

Specifically, as shown in FIG. 3, an end of each first internal electrode 41 on the first positive direction X1 side coincides with an end of the element body 20 on the first positive direction X1 side. Therefore, the end of each first internal electrode 41 on the first positive direction X1 side is exposed at the first end surface 22A. An end of each first internal electrode 41 on the first negative direction X2 side is located inside the element body 20 and does not reach an end of the element body 20 on the first negative direction X2 side. In contrast, an end of each second internal electrode 42 on the first negative direction X2 side coincides with the end of the element body 20 on the first negative direction X2 side. Therefore, the end of each second internal electrode 42 on the first negative direction X2 side is exposed at the second end surface 22B. An end of each second internal electrode 42 on the first positive direction X1 side is located inside the element body 20 and does not reach the end of the element body 20 on the first positive direction X1 side.

As shown in FIG. 3, the electronic component 10 includes a first external electrode 61 and a second external electrode 62. In FIGS. 1 to 3, the first external electrode 61 and the second external electrode 62 are illustrated by two-dot chain lines.

The first external electrode 61 covers the first end surface 22A of the element body 20 and a part of each of the four side surfaces 22C on the first positive direction X1 side. That is, the first external electrode 61 is a five-surface electrode. The first external electrode 61 has a first base electrode 61A and a first metal layer 61B.

The first base electrode 61A is laminated on a portion of the outer surface 21 of the element body 20 including the first end surface 22A. Specifically, the first base electrode 61A covers the first end surface 22A of the element body 20 and a part of each of the four side surfaces 22C on the first positive direction X1 side. In the present embodiment, a material of the first base electrode 61A is copper and a polymer compound including carbon and nitrogen. The compound including carbon and nitrogen is so-called inorganic carbon or organic carbon. An average dimension of the first base electrode 61A in a direction orthogonal to the outer surface 21 of the element body 20, that is, an average thickness of the first base electrode 61A, is several μm. An arithmetic mean roughness of the outer surface 65 of the first base electrode 61A is 0.5 μm or more. Preferably, the arithmetic mean roughness of the outer surface 65 of the first base electrode 61A is 1 μm or more. More preferably, the arithmetic mean roughness of the outer surface 65 of the first base electrode 61A is 5 μm or more. In the present embodiment, the arithmetic mean roughness of the outer surface 65 of the first base electrode 61A is 8 μm. The average thickness and the arithmetic mean roughness are calculated by, for example, capturing a sectional image of the first base electrode 61A with an electron microscope and performing image processing on the image. A detailed configuration of the first base electrode 61A will be described later.

The first metal layer 61B is laminated on the first base electrode 61A. That is, the first metal layer 61B covers the first base electrode 61A from the outside. The first metal layer 61B includes one or more metals selected from copper, nickel, silver, tin, palladium, and gold. In the present embodiment, the first metal layer 61B has an Ni plating layer including nickel as a main component and has an Sn plating layer including tin as a main component. Although illustration is omitted, the first metal layer 61B has a structure in which two layers, namely the Ni plating layer and the Sn plating layer, are laminated in this order from the first base electrode 61A side.

The second external electrode 62 covers the second end surface 22B of the element body 20 and a part of each of the four side surfaces 22C on the second positive direction Y1 side. That is, the second external electrode 62 is a five-surface electrode. The second external electrode 62 has a second base electrode 62A and a second metal layer 62B.

The second base electrode 62A is laminated on a portion of the outer surface 21 of the element body 20 including the second end surface 22B. Specifically, the second base electrode 62A covers the second end surface 22B of the element body 20 and a part of each of the four side surfaces 22C on the first negative direction X2 side. In the present embodiment, a material of the second base electrode 62A is the same as a material of the first external electrode 61. That is, the material of the second base electrode 62A is a compound including copper and carbon as main components. An average thickness of the second base electrode 62A and an arithmetic mean roughness of an outer surface of the second base electrode 62A are the same as those of the first base electrode 61A.

The second metal layer 62B is laminated on the second base electrode 62A. That is, the second metal layer 62B covers the second base electrode 62A from the outside. A material of the second metal layer 62B is the same as that of the first metal layer 61B. That is, the second metal layer 62B has a two-layer structure including an Ni plating layer and an Sn plating layer in this order from the second base electrode 62A side.

The second external electrode 62 does not reach the first external electrode 61 on the side surfaces 22C and is separated from the first external electrode 61 in the direction along the first axis X. On the side surfaces 22C of the element body 20, the first external electrode 61 and the second external electrode 62 are not laminated on a central portion in the direction along the first axis X.

### (Base Electrode)

A configuration of the first base electrode 61A in the first external electrode 61 will be described in detail below. A configuration of the second base electrode 62A is the same as the configuration of the first base electrode 61A, and therefore description is omitted.

As shown in FIG. 4, the first base electrode 61A includes a plurality of copper particles CP inside. The first base electrode 61A has a chain-shaped portion 63 in which a plurality of the copper particles CP are connected. The chain-shaped portion 63 referred to herein does not indicate that ring-shaped objects are connected, but means that copper particles CP having a spherical shape or the like are continuously adjacent to one another. The chain-shaped portion 63 is continuously connected from the outer surface 21 of the element body 20 to the outer surface 65 of the first base electrode 61A on a side opposite to the element body 20. Furthermore, in the chain-shaped portion 63, a plurality of the copper particles CP are connected over 100 nm or more in a direction along the outer surface 21 of the element body 20. In the present embodiment, substantially the entire copper component of the first base electrode 61A forms the chain-shaped portion 63. When the first base electrode 61A is viewed in a cross section orthogonal to the outer surface 21 of the element body 20, a ratio of an area occupied by the copper particles CP to an entire area of the section is 50% to 95%. In the sectional view, the first base electrode 61A has a plurality of gaps G between mutually different portions of the chain-shaped portion 63. A ratio of an area occupied by the gaps G to the entire area of the section is 5% to 50%. Therefore, the chain-shaped portion 63 of the first base electrode 61A forms a spongy structure and has the gaps G as continuous pores inside the spongy structure. The “gaps G between mutually different portions of the chain-shaped portion 63” are a concept including not only gaps G between mutually different portions within one chain-shaped portion 63 but also gaps G between respective portions of a plurality of different chain-shaped portions 63. In addition, the gaps G do not need to be present between all of the chain-shaped portions 63.

A filler 64 contained in the first base electrode 61A is filled in the gaps G. In the present embodiment, substantially all of the gaps G are filled with the filler 64. Therefore, when the first base electrode 61A is viewed in a cross section orthogonal to the outer surface 21 of the element body 20, the filler 64 is filled in the plurality of gaps G. A ratio of an area occupied by the filler 64 to the entire area of the section is 5% to 50%. The filler 64 is a polymer compound including carbon and nitrogen. Therefore, an elastic modulus of the filler 64 is smaller than an elastic modulus of the chain-shaped portion 63. In other words, the filler 64 is softer than the chain-shaped portion 63.

The entire area of the section, the area occupied by the copper particles CP, the area occupied by the gaps G, and the area occupied by the filler 64 in the first base electrode 61A described above are calculated by image processing. Specifically, first, the element body 20 is ground in a direction orthogonal to the outer surface 21 by focused ion beam machining or the like. Next, the ground section is imaged using a transmission electron microscope (TEM). An imaging range at this time is a range in which the first base electrode 61A appears over 5μm or more in a direction along the outer surface 65 of the first base electrode 61A. Then, an area of the first base electrode 61A in the image is defined as the “entire area of the section” described above. An area occupied by the copper particles CP in the range of the image is defined as the “area occupied by the copper particles CP” described above. Then, a value obtained by subtracting the “area occupied by the copper particles CP” from the “entire area of the section” is defined as the “area occupied by the gaps G” described above. An area occupied by the filler 64 in the range of the image is defined as the “area occupied by the filler 64” described above. In calculating these areas, energy dispersive X-ray spectroscopy (EDX) may be used.

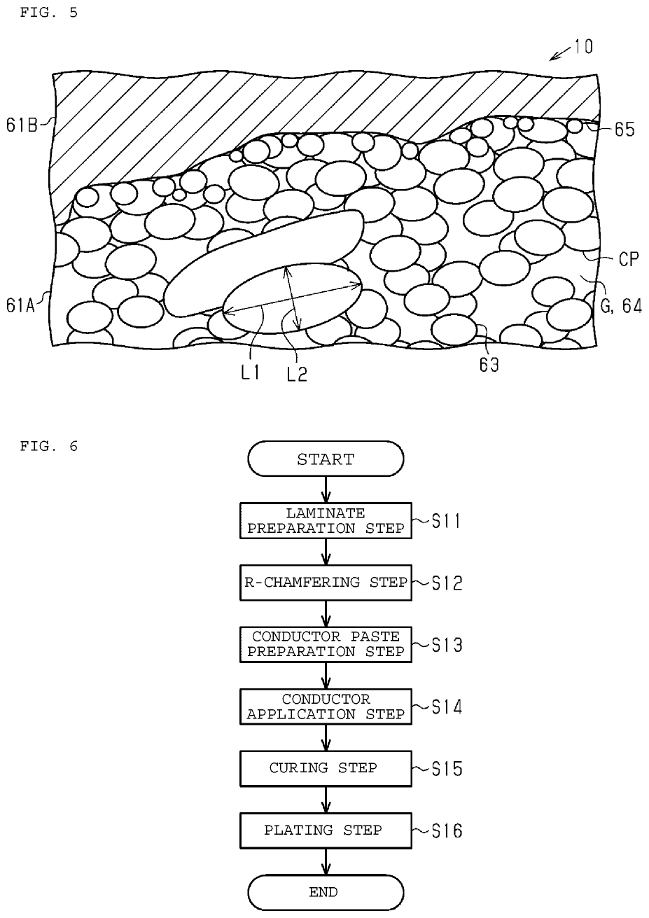

As shown in FIG. 5, when the first base electrode 61A is viewed in a cross section orthogonal to the outer surface 21 of the element body 20, the longest line segment among line segments connecting two points on an outer edge of one copper particle CP is defined as a first line segment L1 of the copper particle CP. Among line segments connecting two points on the outer edge of the copper particle CP, a line segment passing through a midpoint of the first line segment L1 and orthogonal to the first line segment L1 is defined as a second line segment L2 of the copper particle CP. At this time, in most of the plurality of copper particles CP, a dimension of the first line segment L1 is less than two times a dimension of the second line segment L2. That is, most of the copper particles CP have a substantially spherical shape. In at least some of the plurality of copper particles CP, the dimension of the first line segment L1 is two times or more the dimension of the second line segment L2. That is, at least some of the copper particles CP have a flat shape.

In addition, an average value of dimensions of the first line segments L1 of the plurality of copper particles CP in contact with the first metal layer 61B is 50 nm or less. In contrast, an average value of dimensions of the first line segments L1 of the plurality of copper particles CP that are not in contact with the first metal layer 61B and are located proximal to the first metal layer 61B is greater than 50 nm. In particular, in some of the copper particles CP that are not in contact with the first metal layer 61B and are located near the first metal layer 61B, the dimension of the first line segment L1 is several hundred nm. The average value of the dimensions of the first line segment L1 is calculated by randomly selecting 20 or more copper particles CP from the plurality of copper particles CP satisfying the above conditions in a sectional image of the first base electrode 61A.

In addition, an average value of dimensions of the first line segments L1 of the plurality of copper particles CP in contact with the element body 20 is 30 nm or less. Therefore, the dimensions of the first line segment L1 vary among the copper particles CP in contact with the first metal layer 61B, the copper particles CP in contact with the element body 20, and the copper particles CP in contact with neither the first metal layer 61B nor the element body 20. Reflecting such variation in particle diameters of the copper particles CP, in the section of the first base electrode 61A, a standard deviation of dimensions of the first line segments L1 of the plurality of copper particles CP is 50 nm or more. The standard deviation is calculated by randomly selecting 50 or more copper particles CP in a sectional image of the first base electrode 61A.

In this manner, the first base electrode 61A has the chain-shaped portion 63 in which the copper particles CP having different particle diameters are connected, and the gaps G between mutually different portions of the chain-shaped portion 63 are filled with the filler 64. That is, the first base electrode 61A has a dense structure having no voids. Therefore, almost no metal component derived from the first metal layer 61B is diffused inside the first base electrode 61A.

Specifically, as shown in FIG. 4, a portion of the first base electrode 61A that is from the outer surface 65 of the first base electrode 61A and is less than 10% of a dimension of the first base electrode 61A in a direction orthogonal to the outer surface 65 of the first base electrode 61A is defined as a surface-side portion 66. A portion of the first base electrode 61A that is away from the outer surface 65 of the first base electrode 61A by 10% or more of the dimension of the first base electrode 61A in a direction orthogonal to the outer surface 65 of the first base electrode 61A is defined as an inner portion 67. At this time, the surface-side portion 66 contains a metal of the same type as a metal included in the first metal layer 61B. However, a concentration of the metal contained in the surface-side portion 66 is 1/10 or less of a concentration of the metal included in the first metal layer 61B. In addition, the inner portion 67 does not contain a metal of the same type as the metal included in the first metal layer 61B. However, “does not contain” means that a concentration of a metal of the same type as the metal included in the first metal layer 61B in the first base electrode 61A is 1/100 or less of the concentration of the metal included in the first metal layer 61B. As described above, a portion of the first metal layer 61B laminated in contact with the first base electrode 61A is an Ni plating layer. That is, the “metal” described above in the present embodiment is nickel. In addition, the concentration of the metal is measured by composition analysis using a so-called line analysis, point analysis, or the like using an electron microscope. In this case, a unit of the concentration is molar percentage (mol %). In the case of the present embodiment, the concentration of nickel in the surface-side portion 66 of the first base electrode 61A is 10 mol % or less.

### (Manufacturing Method)

Next, a method for manufacturing the electronic component 10 will be described. As shown in FIG. 6, the method for manufacturing the electronic component 10 includes a laminate preparation step S11, an R-chamfering step S12, a conductor paste preparation step S13, a conductor application step S14, a curing step S15, and a plating step S16.

First, in the laminate preparation step S11, a laminate obtained by laminating and firing ceramic sheets to form the element body 20 and conductor paste to form the internal electrodes is prepared. Specifically, first, a plurality of ceramic sheets are prepared. Next, the plurality of sheets and the conductor paste are alternately stacked. That is, the conductor paste is stacked on a ceramic sheet. Another sheet is further stacked on the sheet on which the conductor paste has been laminated. The conductor paste is stacked on the sheet. By stacking the conductor paste a total of eight times in this manner, a stacked body of the ceramic sheets and the conductor paste is produced. Next, the stacked body is pressure-bonded in a lamination direction using a die press or the like. Then, the pressure-bonded laminate is cut to a predetermined size and is shaped. Next, by firing the laminate, the plurality of ceramic sheets form the element body 20 of the electronic component 10. In addition, the conductor paste sandwiched between the plurality of sheets forms the first internal electrodes 41 and the second internal electrodes 42 of the electronic component 10. In the laminate preparation step S11, the laminate fired in this manner is prepared. At this stage, the laminate has a rectangular parallelepiped shape.

Next, the R-chamfering step S12 is performed. In the R-chamfering step S12, curved surfaces are formed in boundary portions between two adjacent planar surfaces 22 and boundary portions among three adjacent planar surfaces 22 of the laminate prepared in the laminate preparation step S11. For example, by R-chamfering corners of the laminate by barrel polishing, curved surfaces are formed in the boundary portions described above.

Next, the conductor paste preparation step S13 is performed. In the conductor paste preparation step S13, a conductor paste in which an amine and a carboxylic acid are added to a solution including copper is prepared. Specifically, the conductor paste is produced as a so-called complex ink. First, a metal salt including copper and an amine as a solvent are mixed. In the present embodiment, the metal salt is powdered copper formate. The amine as the solvent is, for example, a mixture of “2-ethylhexylamine” and “2-amino-methyl-1-propanol”. The mixed solution is stirred for about 24 hours using a stirrer such as a magnetic stirrer. As a result, the powdered copper formate forms a complex and dissolves in the amine. That is, the solution including copper is prepared.

Next, an amine and a carboxylic acid are added as additives to the solution after stirring. In the present embodiment, the amine as the additive is “N, N-diethyl-p-phenylenediamine ((C₂H₅)₂NC₆H₄NH₂)”. The carboxylic acid is hexanoic acid (CH₃(CH₂)₄COOH). Then, a solution including these additives is stirred by a method similar to the method described above. The additives are dispersed in the solution by stirring, whereby the conductor paste is produced. In this state, the conductor paste includes particulate copper and a resin component synthesized by the additives.

Next, the conductor application step S14 is performed. In the conductor application step S14, the conductor paste prepared in the conductor paste preparation step S13 is applied to the element body 20 using a dispenser. Portions where the conductor paste is to be applied are two portions, namely a part of the first end surface 22A of the element body 20 and a part of the second end surface 22B of the element body 20. Specifically, the conductor paste is applied so as to cover the entire region of the first end surface 22A and a part on each of the four side surfaces 22C. In addition, the conductor paste is applied so as to cover the entire region of the second end surface 22B and a part on each of the four side surfaces 22C.

Next, the curing step S15 is performed. In the curing step S15, the conductor paste is cured, thereby forming the first base electrode 61A and the second base electrode 62A on the outer surface 21 of the element body 20. In the present embodiment, the conductor paste is cured by heating the element body 20 to which the conductor paste has been applied under a nitrogen atmosphere in which a heating furnace is filled with nitrogen gas. Specifically, the element body 20 to which the conductor paste has been applied is heated at a temperature of 300 degrees to 1000 degrees. As a result, the conductor paste is fired.

Here, a sintering start temperature of copper included in the conductor paste is lower than a curing start temperature of the resin component. Therefore, when a firing temperature rises, first, sintering of the copper included in the conductor paste starts. That is, the copper particles CP in the conductor paste are sintered, and the chain-shaped portion 63 is formed. At this point of time, curing of the resin component has not started. That is, the resin component has fluidity. Therefore, the resin component of the conductor paste is filled in the gaps G between mutually different portions of the chain-shaped portion 63. Thereafter, when the firing temperature rises to the curing start temperature of the resin component, the resin component starts to cure. In the curing step S15, the copper component is sintered in this manner, whereby the chain-shaped portion 63 formed of the copper particles CP is formed. Next, the resin component fills the gaps G and then cures, whereby portions of the filler 64 of each base electrode are formed. As a result, the first base electrode 61A and the second base electrode 62A as described above are formed.

Next, the plating step S16 is performed. Electroplating is performed on portions of the first base electrode 61A and the second base electrode 62A. As a result, the first metal layer 61B is formed on a surface of the first base electrode 61A. In addition, the second metal layer 62B is formed on a surface of the second base electrode 62A. The first metal layer 61B and the second metal layer 62B have a two-layer structure by being electroplated with two types of metals, nickel and tin. In this manner, the electronic component 10 is formed.

### (Effects of Present Embodiment)

Effects of the present embodiment will be described below. Effects common to the first base electrode 61A and the second base electrode 62A will be described using the first base electrode 61A as a representative example, and description of effects of the second base electrode 62A is omitted.

(1) In the embodiment described above, the first base electrode 61A has the chain-shaped portion 63 in which the copper particles CP are connected. In addition, the chain-shaped portion 63 is in contact with the outer surface 21 of the element body 20 and the first metal layer 61B. Since the chain-shaped portion 63 is included, the gaps G are likely to be formed at a considerable proportion between mutually different portions of the chain-shaped portion 63. Accordingly, the filler 64 is easily filled in the gaps G. Therefore, voids not filled with the filler 64 are unlikely to be formed in the first base electrode 61A. Therefore, entry of a liquid such as a plating solution into the inside of the first base electrode 61A can be suppressed.

(2) In the embodiment described above, an elastic modulus of the filler 64 is smaller than an elastic modulus of the chain-shaped portion 63. Therefore, even when stress acts on the first base electrode 61A, such as when a physical impact is applied from the outside, the stress can be absorbed by elastic deformation of the filler 64. As a result, cracks are unlikely to occur in the first base electrode 61A.

(3) In the embodiment described above, when the first base electrode 61A is viewed in section, an area occupied by the copper particles CP relative to a sectional area of the entire first base electrode 61A is 50% to 95%. With this ratio, the filler 64 can be filled entirely in the first base electrode 61A while electrical conductivity by the copper particles CP is ensured.

(4) In the embodiment described above, an arithmetic mean roughness of the outer surface 65 of the first base electrode 61A is 0.5 μm or more. Accordingly, adhesion strength between the first metal layer 61B and the first base electrode 61A is increased by a so-called anchor effect. Therefore, the first metal layer 61B is unlikely to peel from the first base electrode 61A.

(5) In the embodiment described above, at least some of the plurality of copper particles CP have a flat shape. The flat-shaped copper particles CP are in contact with more other copper particles CP than the spherical-shaped copper particles CP. Therefore, the chain-shaped portion 63 in which the copper particles CP are connected is formed easily. In addition, by contacting more copper particles CP, a sectional area of the chain-shaped portion 63 serving as an electron conduction path increases. That is, for example, a reduction in electrical resistance of the entire first base electrode 61A can be expected as compared with a case where the chain-shaped portion 63 is constituted only by substantially spherical-shaped copper particles CP.

(6) In the embodiment described above, an average value of dimensions of the first line segments L1 of the copper particles CP in contact with the first metal layer 61B is 50 nm or less. As described above, because the particle diameters of the copper particles CP closest to the first metal layer 61B side are sufficiently small, a total surface area of the copper particles CP is large at an interface between the first metal layer 61B and the first base electrode 61A. Therefore, strength of adhesion between the first metal layer 61B and the first base electrode 61A is increased by the anchor effect.

(7) In the embodiment described above, a standard deviation of dimensions of the first line segments L1 of the plurality of copper particles CP is 50 nm or more. That is, particle diameters of the copper particles CP have considerable variation. As a result, copper particles CP having small particle diameters enter gaps between other copper particles CP easily. Therefore, the plurality of copper particles CP easily come into contact with one another, and the chain-shaped portion 63 easily spreads over a wide range. Since the chain-shaped portion 63 spreads widely, an electrical conduction path in the first base electrode 61A is hardly interrupted.

(8) In the embodiment described above, the inner portion 67 of the first base electrode 61A does not contain a metal of the same type as a metal included in the first metal layer 61B. In addition, the surface-side portion 66 of the first base electrode 61A contains a metal of the same type as the metal included in the first metal layer 61B, but a concentration of the metal is 1/10 or less of a concentration of the metal in the first metal layer 61B. That is, a metal component of the first metal layer 61B is hardly diffused into the first base electrode 61A. In a case where the metal has entered to the inner portion 67 of the first base electrode 61A, an electrical resistance value is likely to increase. According to the present configuration, such a situation can be prevented.

(9) In the embodiment described above, the first metal layer 61B includes one or more metals selected from copper, nickel, silver, tin, palladium, and gold. At least with such a metal, diffusion of the metal from the first metal layer 61B into the first base electrode 61A can be significantly suppressed.

(10) In the embodiment described above, the filler 64 is a compound including carbon and nitrogen. Therefore, an elastic modulus of the filler 64 is likely to be smaller than an elastic modulus of the copper particles CP. As a result, even when stress is applied from the outside, the stress is easily absorbed by elastic deformation of the filler 64.

(11) In the embodiment described above, in the conductor paste preparation step S13, the conductor paste is prepared by adding an amine and a carboxylic acid to a solution including copper. Since the conductor paste is prepared in this manner, the chain-shaped portion 63 is easily formed in each base electrode in the curing step S15.

(12) In the embodiment described above, in the curing step S15, first, the copper component of the conductor paste is fired, and the chain-shaped portion 63 formed of the copper particles CP is formed. Thereafter, the resin component of the conductor paste is fired. At this time, the resin component shrinks by the firing. The chain-shaped portion 63 extends or deforms as positions of the copper particles CP shift with shrinkage of the surrounding resin component. That is, even when the resin component shrinks, the chain-shaped portion 63 is unlikely to break. Therefore, electrical conductivity of the base electrode is unlikely to be impaired. In particular, the base electrode is likely to become thin by firing at edges of the side surfaces 22C of the element body 20, but according to the present configuration, electrical conductivity is unlikely to be impaired even at such portions.

### <Modifications>

The embodiment described above can be implemented with modifications as described below. The embodiment described above and the following modifications can be implemented in combination with one another within a technically consistent range.
The electronic component 10 is not limited to a multilayer ceramic capacitor. For example, the electronic component 10 may be a piezoelectric component, a thermistor, an inductor, or the like having the element body 20, the first external electrode 61, and the second external electrode 62.
A material of the element body 20 may be a dielectric, a piezoelectric body, a magnetic body such as ferrite, a composite body of a filler and a metal, or the like.
The conductor paste may be nano-ink. In a case of nano-ink, nanometal powder including particulate copper is dispersed in a solvent including cellosolves, carbitols, hydrocarbons, aromatics, and the like. Then, the conductor paste can be produced by adding an amine and a carboxylic acid as additives.
When the conductor paste is complex ink, the amine and the carboxylic acid as additives are not limited to the examples in the embodiment described above. The amine as the additive may be, for example, “N, N-dimethyl-1,3-propanediamine”, “1,2-propanediamine”, “m-xylene-α,α′-diamine”, “N,N,N′,N′-tetramethyl-p-phenylenediamine”, “N,N-dibutyl-1,3-propanediamine”, “p-phenylenediamine”, “ethylenediamine”, “N,N-dimethylethylenediamine”, “N,N,N′,N′-tetramethylethylenediamine”, “1,4-butanediamine”, “N,N,N′,N′-tetramethyl-1,6-hexanediamine”, “hexamethylenediamine”, “1,5-naphthalenediamine”, “1,12-dodecanediamine”, “1,8-octanediamine”, “o-phenylenediamine”, “m-phenylenediamine”, “N,N′-dimethylethylenediamine”, “4-methyl-1,2-phenylenediamine”, “1,3-propanediamine”, “N,N-diethyl-1,3-propanediamine”, or the like. In addition, the carboxylic acid may be, for example, formic acid, acetic acid, propionic acid, butanoic acid, heptanoic acid, valeric acid, octanoic acid, decanoic acid, or the like.
The numbers of the first internal electrodes 41 and the second internal electrodes 42 are not limited to the examples in the embodiment described above. The number of the first internal electrodes 41 may be less than four or more than four. The same applies to the second internal electrodes 42.
When the first base electrode 61A is viewed in a cross section orthogonal to the outer surface 21 of the element body 20, a ratio of an area occupied by the copper particles CP to the entire area of the section may be less than 50% or greater than 95%. Even in such a case, entry of a liquid into the inside of the base electrode can be suppressed by filling the gaps G with the filler 64.
An arithmetic mean roughness of the outer surface 65 of the first base electrode 61A may be less than 0.5 μm. Even in such a case, at least the effect described in (1) above is obtained. The same applies to the second base electrode 62A.
The copper particles CP do not have to include flat-shaped particles. That is, in all of the copper particles CP, a dimension of the first line segment L1 may be less than two times a dimension of the second line segment L2. In addition, an average value of dimensions of the first line segments L1 of the plurality of copper particles CP in contact with each metal layer may be greater than 50 nm. Regardless of shapes and sizes of the copper particles CP, the base electrode only needs to have the chain-shaped portion 63.
The inner portion 67 of the first base electrode 61A may contain a metal of the same type as the first metal layer 61B. However, a concentration of the metal contained in the inner portion 67 is preferably 1/10 or less of a concentration of the metal included in the first metal layer 61B. The same applies to the second base electrode 62A.
A concentration of the metal contained in the surface-side portion 66 of the first base electrode 61A may be greater than 1/10 of a concentration of the metal included in the first metal layer 61B. Even in such a case, a concentration of the metal in the inner portion 67 only needs to be small. The same applies to the second base electrode 62A.
A method for measuring the concentration of the metal is not limited to the example in the embodiment described above. For example, measurement may be performed by EDX. In the case of this method, specifically, first, the element body 20 is ground in a direction orthogonal to the outer surface 21 by focused ion beam machining or the like. Next, the ground section of the element body 20 is irradiated with an electron beam using TEM. A range irradiated with the electron beam is a range of 1 μm or more in a direction along the outer surface 65 of the first base electrode 61A. By measuring a dose of characteristic X-rays generated at this time, mapping data of a composition in the section is acquired. The mapping data is data in an image format. In the mapping data, a portion with a higher dose of characteristic X-rays has a higher luminance value in the image. That is, in the mapping data, a portion with a larger amount of the composition has a higher luminance value in the image. Therefore, a concentration of the composition in a specific region of the mapping data is calculated by dividing a total value of luminance values present in the region by an area of the region. The concentration in this case is represented by an average luminance value per unit area. In this manner, a concentration of nickel in the first metal layer 61B, a concentration of the surface-side portion 66, and a concentration of the inner portion 67 may be measured and compared. A unit of the concentration may be molar percentage (mol %), mass percent concentration (wt %), or the like.
A material of the filler 64 is not limited to the example in the embodiment described above. For example, the filler 64 may be a synthetic resin. In addition, the filler 64 does not have to be a polymer compound and may consist only of carbon. Furthermore, the filler 64 does not have to include carbon or nitrogen. For example, the filler 64 may be a silicone resin.
The electronic component 10 may include a glass film. In that case, for example, the glass film may be formed so as to cover a partial region of the outer surface 21 of the element body 20. In other words, even when the glass film covering the element body 20 is present, the electrical connection between the first internal electrodes 41 and the first external electrode 61 and the electrical connection between the second internal electrodes 42 and the second external electrode 62 only need to be ensured.
In the conductor application step S14, a method for attaching the conductor paste to the outer surface 21 of the element body 20 is not limited to the example in the embodiment described above. For example, the conductor paste may be printed on the outer surface 21 of the element body 20 by a so-called inkjet method, a screen printing method, or the like.
In the curing step S15, the firing may be performed in a plurality of times. For example, in a case where the firing is performed in two times, first, the element body 20 may be fired at a temperature of 200 degrees to 400 degrees for a predetermined time. Next, after the element body 20 is taken out from the heating furnace and a predetermined operation is performed, the element body 20 may be subjected to main firing at a temperature of 300 degrees to 1000 degrees.
A magnitude of a difference between the sintering start temperature of the copper component of the conductor paste and the curing start temperature of the filler 64 may vary depending on a material of the filler 64. In order to keep the copper component included in the conductor paste in a particulate form, the filler 64 made of a material with which the difference between the above start temperatures is 100 degrees or less is preferably employed.
The sintering start temperature of the copper included in the conductor paste may be equal to or higher than the curing start temperature of the resin component. Sintering of the copper proceeds in the same step as curing of the resin component, whereby the filler 64 may be filled between the copper particles CP, that is, between mutually different portions of the chain-shaped portion 63.

### DESCRIPTION OF REFERENCE SYMBOLS

10: Electronic component
20: Element body
21: Outer surface
61: First external electrode
61A: First base electrode
61B: First metal layer
62: Second external electrode
62A: Second base electrode
62B: Second metal layer
CP: Copper particle
L1: First line segment
L2: Second line segment
63: Chain-shaped portion
64: Filler
65: Outer surface
G: Gap

1. An electronic component comprising:
an element body; and
an external electrode covering an outer surface of the element body,
wherein the external electrode has a base electrode that includes a plurality of copper particles and a filler,
the base electrode has a chain-shaped portion in which a plurality of the copper particles are continuously connected from the outer surface of the element body to an outer surface of the base electrode on a side thereof opposite to the element body, and in which the plurality of the copper particles are connected over 100 nm or more in a direction along the outer surface of the element body,
when viewed in a cross section orthogonal to the outer surface of the element body, a gap is defined between mutually different portions of the chain-shaped portion, and
the filler is in the gap.

2. The electronic component according to claim 1, wherein, when the base electrode is viewed in the cross section orthogonal to the outer surface of the element body, a ratio of an area occupied by the plurality of the copper particles to an entire area of the section is 50% to 95%.

3. The electronic component according to claim 1, wherein an arithmetic mean roughness of the outer surface of the base electrode is 0.5 μm or more.

4. The electronic component according to claim 1, wherein, when the base electrode is viewed in the cross section orthogonal to the outer surface of the element body, a longest line segment among line segments connecting two points on an outer edge of a first copper particle of the plurality of the copper particles is defined as a first line segment, and a line segment passing through a midpoint of the first line segment and orthogonal to the first line segment is defined as a second line segment of the copper particle, in at least some of the plurality of copper particles a dimension of the first line segment is at least two times a dimension of the second line segment.

5. The electronic component according to claim 1, wherein
the external electrode has a metal layer covering the outer surface of the base electrode, and
when the base electrode is viewed in the cross section orthogonal to the outer surface of the element body and a longest line segment among line segments connecting two points on an outer edge of a copper particle of the plurality of the copper particles is defined as a first line segment, an average value of dimensions of the first line segment of a multitude of copper particles of the plurality of the copper particles that are in contact with the metal layer is 50 nm or less.

6. The electronic component according to claim 1, wherein, when the base electrode is viewed in the cross section orthogonal to the outer surface of the element body and a longest line segment among line segments connecting two points on an outer edge of a copper particle of the plurality of the copper particles is defined as a first line segment, a standard deviation of dimensions of the first line segment of a multitude of copper particles of the plurality of the copper particles is 50 nm or more.

7. The electronic component according to claim 1, wherein
the external electrode has a metal layer covering the outer surface of the base electrode, and
an inner portion of the base electrode that is away from the outer surface of the base electrode by 10% or more of a dimension of the base electrode in a direction orthogonal to the outer surface of the base electrode does not contain a metal of a same type as a metal included in the metal layer.

8. The electronic component according to claim 1, wherein
the external electrode has a metal layer covering the outer surface of the base electrode,
a surface-side portion of the base electrode that is less than 10% of a dimension of the base electrode in a direction orthogonal to the outer surface of the base electrode from the outer surface of the base electrode contains a metal of a same type as a metal included in the metal layer, and
a concentration of the metal contained in the surface-side portion is 1/10 or less of a concentration of the metal included in the metal layer.

9. The electronic component according to claim 1, wherein
the external electrode has a metal layer covering the outer surface of the base electrode, and
the metal layer includes one or more metals selected from copper, nickel, silver, tin, palladium, and gold.

10. The electronic component according to claim 1, wherein the filler includes carbon.

11. The electronic component according to claim 10, wherein the filler includes nitrogen.

12. The electronic component according to claim 1, wherein the filler has an elastic modulus smaller than an elastic modulus of the chain-shaped portion.

13. The electronic component according to claim 1, wherein, when the base electrode is viewed in the cross section orthogonal to the outer surface of the element body, the gap is a plurality of gaps, and a ratio of an area occupied by the plurality of the gaps to an entire area of the cross section is 5% to 50%.

14. The electronic component according to claim 1, wherein, when the base electrode is viewed in the cross section orthogonal to the outer surface of the element body, a ratio of an area occupied by the filler to an entire area of the cross section is 5% to 50%.

15. The electronic component according to claim 1, wherein an entire copper component of the base electrode forms the chain-shaped portion.

16. The electronic component according to claim 1, wherein the external electrode has a metal layer covering the outer surface of the base electrode, and when the base electrode is viewed in the cross section orthogonal to the outer surface of the element body and a longest line segment among line segments connecting two points on an outer edge of a copper particle of the plurality of the copper particles is defined as a first line segment, an average value of dimensions of the first line segments of a multiplicity of copper particles of the plurality of the copper particles that are not in contact with the metal layer and are located proximal to the metal layer is greater than 50 nm.

17. A method for manufacturing an electronic component, the method comprising:
preparing an element body;
preparing a conductor paste in which an amine and a carboxylic acid are added to a solution including copper;
applying the conductor paste to an outer surface of the element body; and
curing the conductor paste to form a base electrode on the outer surface of the element body.

18. The method for manufacturing an electronic component according to claim 17, further comprising forming a metal layer on a surface of the base electrode.

19. The method for manufacturing an electronic component according to claim 17, wherein the solution including copper is prepared by mixing a metal salt including copper with an amine solvent.

20. The method for manufacturing an electronic component according to claim 17, wherein the conductor paste is a nano-ink in which nanometal powder including copper is dispersed in a solvent.
